(19) United States
(12) Patent Application Publication
(10) Pub. No.: US 2022/0279783 A1
(43) Pub. Date: Sep. 8, 2022

(54) COMPOSITIONS, METHODS, AND SYSTEMS FOR CONTROLLING INVASIVE MUSSEL SPECIES

(71) Applicant: Clyde Morgan, Gardner, KS (US)

(72) Inventor: Clyde Morgan, Gardner, KS (US)

(21) Appl. No.: 17/686,125

(22) Filed: Mar. 3, 2022

Related U.S. Application Data
(60) Provisional application No. 63/156,429, filed on Mar. 4, 2021.

(51) Int. Cl. A01N 25/08; A01N 25/00; A01N 65/08; C02F 1/50

(52) U.S. Cl. CPC A01N 25/08; A01N 25/008; A01N 65/08; C02F 1/50

(57) ABSTRACT

Methods and systems for killing, preventing, or inhibiting the growth and spread of invasive Dreissenid mussel species, such as Zebra mussels (Dreissena polymorpha) and Quagga mussels (Dreissena rostriformis bugensis) are provided herein. The treatment methods and systems utilize a composition comprising a source of solids (such as a source of fibrous material) and an attractant, which is introduced to a body of water. The composition effectively kills or prevents the spreading of the invasive mussel species in the bodies of water. The methods and systems of the present invention advantageously avoid the use of heavy metals or pesticides that may pose health risks to humans. Additionally, embodiments of the present invention can use treatment doses that are nonharmful to other aquatic life.

### CROSS-REFERENCE TO RELATED APPLICATIONS

The present application claims the priority benefit of U.S. Provisional Patent Application Ser. No. 63/156,429, filed Mar. 4, 2021, entitled COMPOSITIONS, METHODS, AND SYSTEMS FOR CONTROLLING INVASIVE MUSSEL SPECIES, incorporated by reference in its entirety herein.

### BACKGROUND OF THE INVENTION

### Field of the Invention

The present invention is generally directed to water treatments effective for killing or preventing the spread of invasive mussel species.

### Description of Related Art

Dreissenid mussels, also known as Zebra Mussels & Quagga Mussels, are one of the most biological invasive species in North American waters. Zebra mussels are notorious for their biofouling capabilities by colonizing water supply pipes of hydroelectric and nuclear power plants, public water supply plants, and industrial facilities. They colonize pipes constricting flow, therefore reducing the intake in heat exchangers, condensers, fire-fighting equipment, and air conditioning and cooling systems. Navigational and recreational boating can be affected by increased drag due to attached mussels. Small mussels can get into engine cooling systems causing overheating and damage. Navigational buoys have been sunk under the weight of attached zebra mussels. Fishing gear can be fouled if left in the water for long periods. Deterioration of dock pilings has increased when they are encrusted with zebra mussels. Continued attachment of zebra mussels can cause corrosion of steel and concrete affecting its structural integrity.

Containment of invasive mussels can be difficult and cost prohibitive, particularly when the volume of water to be treated is large. For example, a paper company plant located on Lake Michigan spent $1.4 million for removal of zebra mussels from 400 cubic yards near plant equipment. Some current methods of controlling invasive mussels include chemical, bromine, quaternary and polyquaternary ammonium compounds, aromatic hydrocarbons, copper (heavy metal), endothall, over population of bacteria, coatings, UV light, filtration, mechanical, and operational.

What is needed is an improved, low-cost method of treating and controlling the spread of invasive mussel species.

### SUMMARY OF THE INVENTION

In one embodiment, there is provided a method of controlling the spread of an invasive Dreissenid mussel species. The method comprises introducing a composition to a body of water. The composition comprises a source of solids (or fibrous material) and an attractant.

In another embodiment, there is provided a method of controlling the spread of an invasive Dreissenid mussel species. The method comprises introducing a composition to a body of water. The composition comprises corn gluten meal.

In another embodiment, there is provided a composition for controlling the spread of an invasive Dreissenid mussel species. The composition comprises a source of solids (or fibrous material), an attractant, and optionally, an anti-caking agent.

### BRIEF DESCRIPTION OF THE DRAWINGS

Figures (FIGS. 1-3 are photographs showing oxalate concentration testing of diluted sesame in accordance with embodiments of the present invention;

FIG. 4 is a photograph showing Zebra Mussels covered with dry biomass for 12 hours;

FIG. 5 is a photograph showing the Zebra Mussels of FIG. 4 immediately after washing, showing the closed position of all specimens;

FIG. 6 is a photograph showing the Zebra Mussels of FIGS. 4 and 5 filtering and digesting after being washed off and placed in new fresh water;

FIG. 7 is a photograph showing one of the Zebra Mussels of FIGS. 4-6 four hours after the Zebra Mussels were washed and placed in new water, wherein the Zebra Mussel was discovered to be dead, the photograph showing a green tint throughout from the biomass;

FIG. 8 is a microscope photograph (4×) of the digestive tract of the Zebra Mussel of FIG. 7, showing signs of blockage and digestive track filled will biomass;

FIG. 9 is a photograph showing live Zebra Mussels prior to treatment;

FIG. 10 is a photograph showing the addition of corn gluten meal treatment to the Zebra Mussels of FIG. 9;

FIG. 11 is a photograph showing the Zebra Mussels of FIG. 9 immediately after the treatment of FIG. 10;

FIG. 12 is a photograph showing one of the Zebra Mussels of FIGS. 9-11 two hours after treatment, wherein the Zebra Mussel was discovered to be dead, the photograph showing an engorged orange (dark) region;

FIG. 13 is a photograph showing the Zebra Mussels of FIGS. 9-11 after 25 days post treatment; and

FIG. 14 is a magnified photograph showing the Zebra Mussels of FIGS. 9-11 after 25 days post treatment.

### DETAILED DESCRIPTION

The present invention is generally directed to methods and systems for killing, preventing, and/or inhibiting the growth and spread of invasive Dreissenid mussel species, such as Zebra mussels (Dreissena polymorpha) and Quagga mussels (Dreissena rostriformis bugensis), by treating bodies of water with a composition comprising a source of solids (such as fibrous material) and an attractant. Without being bound by any theory, it is believed that the intake of the fibrous materials leads to blockage and suffocation by the filter feeding invasive mussels. Additionally, without being bound by any theory, it is believed that the presence of the attractant increases activity and intake of nutrients, including the fibrous material, by the mussels, which leads to increased blockage and suffocation.

The source of solids may be any suitable solid material effective to cause blockage and/or suffocation to the mussels. In certain embodiments, the source of solids comprises a source of fibrous materials. Examples of suitable fibrous materials comprise (consist of, or consist essentially of) a plurality of any number of natural or synthetic fibers. For example, in certain embodiments, the source of fibrous material may comprise (consist of, or consist essentially of) fibers selected from the group consisting of plants and algae (e.g., cellulosic fibers), plastic, polymers, textiles, rubber, paper, glass, animalia tissues or feces, and mixtures thereof. In certain preferred embodiments, the fibrous material is a cellulosic fibrous material. In certain such embodiments, the source of fibrous material may be a processed aquatic or nonaquatic plant. In certain embodiments, the source of fibrous material is a nonnative aquatic plant or organism and/or a nonnative nonaquatic plant or organism. As used herein, the term “nonnative” refers to a plant or organism that is not indigenous or naturally present in the body of water being treated. This can include aquatic and nonaquatic plants and/or organisms (indigenous or otherwise) that have been artificially modified or processed (e.g., pulverized, blended, liquified, etc.) so as to be in a non-natural form before being introduced to the body of water. For example, leaves, stems, and/or other plant parts may be harvested from aquatic and/or nonaquatic plants and artificially processed to form the nonnative plant or organism. In certain embodiments, the source of fibrous material is a plant and/or organism selected from the group consisting of corn or corn by-product(s), sesame, cyanobacteria, alfalfa, soybeans, wheat grass, wheat straw, barley grass, mulberry, chlorella, seaweed, freshwater moss, spirulina, garlic, wormwood, colocynth, bay laurel, pennyroyal, myrtle, oleander, basil, marjoram, thyme, algae, and mixtures thereof. In particularly preferred embodiments, the source of fibrous material comprises sesame, spirulina, and/or alfalfa. In certain same or other preferred embodiments, the source of fibrous material comprises (consists of, or consists essentially of) corn or corn by-product(s) (e.g., corn gluten meal). In certain embodiments, the fibrous material comprises fibers having an average length of about 0.05 μm to about 650 μm, preferably about 0.2 μm to about 500 μm, and more preferably about 40 μm to about 400 μm.

In certain embodiments, the source of solids (or fibrous material) comprises an aquatic or nonaquatic plant (including algae species) or plant part that has been artificially processed. In such embodiments, certain considerations should be made during processing of the plant or plant part so as to release the aroma and taste of the plant while retaining its fibers and/or oils. For example, processed corn may produce by-products, such as corn gluten meal, that include released proteins, fats, and/or other nutrients from the corn kernel, along with the kernel fibers. In certain embodiments, the source of fibrous material comprises processed plant particles (e.g., powder particles) having an average diameter of about 0.05 μm to about 650 μm, preferably about 0.2 μm to about 500 μm, and more preferably about 40 μm to about 400 μm. Without being bound by any theory, it is believed particles sizes within these ranges allow for normal ingestion and filtration by the mussels. The size can be determined at the time of application or after dissolving or breaking up when in contact with a liquid or water environment.

The attractant may be any natural or synthetic flavoring, additive, or other substance that increases activity and intake by the mussels. The attractant may comprise a single component or a mixture of components. Moreover, the attractant may be separate from the source of solids (or fibrous material) or may be derived from the same source as the fibrous material (i.e., a single source provides both the fibrous material and the attractant). In certain embodiments, the attractant is selected from the group consisting of corn by-product(s) (including corn gluten meal), sugar (including monosaccharides, such as glucose, fructose, galactose, and disaccharides, such as sucrose, lactose, maltose), nonnative sources of favorable flavors (including aquatic and nonaquatic plants or legumes or algae, which may be the same as or different from the source of fibrous material), blended fish or fish meal, corn syrup, alcohols, hemp, and mixtures thereof. In certain embodiments, soured or spoiled attractant sources, such as decayed or decaying animal sources, should be avoided.

In certain embodiments, the attractant comprises a corn by-product. For example, in certain embodiments, the attractant comprises (consists of, or consists essentially of) corn gluten meal. In certain such embodiments, the corn gluten meal may be an attractant and a source of solids/fibrous material. As used herein, “corn gluten meal” refers to a by-product of corn processing (e.g., wet-milling, dry milling, etc.) in the production of corn products, such as corn syrup, corn starch, ethanol, etc., and generally comprises about 40% to about 80% by weight crude protein content, about 1% to about 5% by weight crude fat content, about 1% to about 3% by weight crude fiber content (up to about 20% by weight of total fiber content), about 1% to about 5% by weight mineral content (e.g., calcium, phosphorous), and about 1% to about 20% by weight residual starch content. The protein content of corn gluten meal comprises predominantly zein and glutelin.

In certain embodiments, the attractant comprises a nonnative source of chlorophyll. Chlorophyll is a group of green pigments present in cyanobacteria and in the chloroplasts of plants and algae that absorb light for photosynthesis. There are five types of chlorophyll: chlorophyll a, which is present in all photosynthetic organisms except bacteria; chlorophyll b, in plants and green algae; and chlorophylls c, d and e, in some algae. In certain embodiments, the nonnative source of chlorophyll comprises a quantity of chlorophyll-a, which is believed to be particularly desirable to mussels. In certain embodiments, the nonnative source of chlorophyll may comprise artificial chloroplasts or other source of synthetic (i.e., manmade) chlorophyll. Exemplary nonnative sources of chlorophyll and related treatments are described in U.S. Pat. No. 10,863,747 and U.S. Patent Application Publication No. 2021/0068403, both of which are incorporated herein in their entireties.

Although a variety of solids (or fibrous materials) and attractants can be used in accordance with embodiments of the present invention, certain sources of fibrous materials and attractants, and specifically certain plant sources, should preferably be avoided. For example, in certain embodiments, plant sources having a high oxalic acid (including oxalate salt) content are avoided. Without being bound by any theory, it is believed that Dreissenid mussel species recognize certain chemicals, such as oxalic acid, as being potentially harmful and therefore refrain from filter feeding when such chemicals are present in the water environment. Thus, when plants having high oxalic acid content are used as the source of fibrous material, intake of the fibrous material (and thus efficacy of the composition) is reduced. However, without being bound by any theory, it is believed that certain juvenile plants do not contain high levels of oxalic acid and thus such juvenile plants may be used as a source of fibrous material and/or attractant, while the mature versions of the plants should be avoided. For example, in certain embodiments, the composition does not comprise mature sesame as a source of fibrous material or attractant (or otherwise). However, in certain embodiments, the composition may comprise juvenile sesame as the source of fibrous material and/or attractant. In certain embodiments, the composition comprises less than about 0.1% by weight, preferably less than 0.01% by weight, or is more preferably substantially free of oxalic acid (including oxalates).

Compositions comprising the source of solids (or fibrous material) and attractant can be in a variety of forms. Moreover, the compositions can be provided as a single formulation, or the fibrous material and attractant can be introduced to the body of water as separate components in accordance with methods described herein. In certain embodiments, the composition (or individually, the fibrous material and/or attractant) is provided in a form selected from the group consisting of liquid (including solutions, suspensions, or dispersions), paste, powder, pellets, cubes, blocks (both immediate or time release), animalia food, and combinations thereof. In certain embodiments, the composition (or individually, the fibrous material and/or attractant) may be mixed with natural or synthetic binders, such as cellulose, lignin, and/or other polymer binders. In certain embodiments, the composition (including attractant, source of fibrous material, or both) may be processed to reduce particle size. For example, the attractant and/or source of fibrous material may be provided or purchased as pellets or granules, which may have, for example, an average particle size (i.e., median particle diameter, D50) of about 0.08 inch to about 0.15 inch. Prior to introducing the composition to the body of water, such large pellets or granules may be size reduced (e.g., grinding, milling, etc.) to form a fine powder composition to allow for mussel filtration of the composition. Thus, in certain embodiments, the composition (including the attractant and/or source of fibrous material) may be processed or size reduced from its original or purchased form to provide a powder having a D50 of about 0.00001 inch to about 0.04 inch, preferably about 0.002 inch to about 0.008 inch.

In certain embodiments, the composition may be mixed with an anti-caking agent, such as corn starch. However, in certain other embodiments, no binders are necessary, and thus the composition (or individually, the fibrous material and/or attractant) consists of, or consists essentially of, the fibrous material and the attractant.

Solids (or fibrous materials) and attractants may be included in the compositions at a wide range of levels and may vary depending on factors, such as the size, temperature, and pH of the body of water, whether there is an active infestation of invasive mussels, and the sources of fibrous material and attractants included. Moreover, as noted above, the solids (or fibrous material) and attractant may be derived from the same source, and thus the relative amount of each component can depend on the compositional makeup of the source. However, in certain embodiments, the compositions may comprise about 50% to about 99% by weight, or about 75% to about 95% by weight of fibrous material, and/or about 1% to about 50% by weight, or about 5% to about 25% by weight of the attractant.

In certain preferred embodiments, the composition comprises (consists of, or consists essentially of) corn gluten meal as a source of solids and/or an attractant. For example, in certain embodiments, the compositions may comprise at least about 90%, at least about 95%, at least about 99%, or 100% corn gluten meal. In such embodiments, corn gluten meal is the source of solids and the attractant. Such embodiments may be particularly beneficial when Dreissena mussel control is the only concern.

However, for applications where environmental factors and/or other aquatic life are concerned, the environmental benefit of favorable flavor, fiber, and nutrient mixtures may be considered. Important nutrients that affect aquatic species may be depleted by over population of Dreissena polymorpha (Zebra Mussels and Quagga Mussels), due to over filtering and wasting of valuable nutrients. Thus, the compositions according to certain embodiments of the present invention may benefit aquatic life by both controlling the invasive mussel population and providing supplemental nutrients to the remaining aquatic life. The particular sources of solids and/or attractant may therefore be selected to provide an appropriate balance of invasive mussel control and nutrient supplementation for desirable aquatic life. To this end, in certain embodiments, the composition may comprise a mixture of corn gluten meal and other sources of flavors and/or fibers, for example, to decrease the total protein percentage for easier digestion and in consideration of possible nutritional benefits to other aquatic life, such as gastropod (snails), mollusk (clams), crustaceans (crayfish), amphibian (tadpoles form of frogs), plankton (including phytoplankton and zooplankton), newly hatched fish, cattle, chickens, turkeys, dogs, and the like. In certain embodiments, the composition comprises corn gluten meal and a nonnative source of flavors and/or fibers. In certain such embodiments, the composition may comprise from about 1% to about 50%, about 5% to about 25%, or about 10% to about 20% by weight corn gluten meal and/or from about 50% to about 99%, about 75% to about 95%, or about 80% to about 90% by weight of the nonnative source of attractant (or flavors) and/or fibers. In certain such embodiments, the nonnative source of flavor(s) and/or fiber(s) comprises alfalfa.

Methods of controlling the invasive mussel species comprise introducing the composition comprising the source of solids (or fibrous material) and attractant to a body of water. The body of water may comprise the invasive mussel species, or the body of water may not comprise the invasive mussel species but be susceptible to infestation. Moreover, the composition may be applied directly onto unsubmerged mussels and/or onto unsubmerged structures susceptible to infestation, which are later submerged into the body of water. The body of water may be an open or closed water system and may be internal or external environment. The body of water may include, but is not limited to, lakes, reservoirs, ponds, streams, rivers, processing facilities, and aquariums. As used herein, the “body of water” may refer to the entirety of the water contained within the system or only a localized portion of the water within the system, for example a localized portion of the water in the surrounding water proximate to the invasive mussel species or structure susceptible to infestation (e.g., docks, dams, rocks, etc.). The body of water may also comprise one or more structures submerged in the body of water including, but not limited to, piping, pumps, inlets, outlets, ballast, piers, boats, and other structures both manmade and nature made. The body of water may also comprise natural and non-natural structures including, but not limited to, wood, cement, hard surfaces, mud, and remains of other mussels. Invasive mussel species often aggregate and grow on one or more of the above-noted structures in the body of water, and thus the fibrous material and attractant are preferably introduced to the body of water at a location proximate to such structures.

The composition may be introduced to the body of water by a variety of methods including, for example, pouring, spreading, or spraying the composition onto the surface of the body of water, or injecting the composition into the body of water below the surface. In other embodiments, for example when the composition is provided as an animal food, the nonnative source of attractant (flavor) and/or fiber may be introduced to the body of water by feeding the composition to an animalia and allowing the animalia to defecate at a location proximate to the invasive mussel species or structures susceptible to infestation.

The amount of the composition introduced to the body of water can depend on a number of factors. As noted above, in certain embodiments, the composition comprises a nonnative source of attractant (flavor) and/or fiber. In certain such embodiments, the nonnative source of attractant (flavor) and/or fiber is introduced to the body of water so as to provide an attractant and/or fiber concentration in the body of water at a concentration of at least about 3 grains per gallon (gr/gal), preferably at least about 15 gr/gal. In certain embodiments, the composition is introduced to the body of water so as to provide an attractant (flavoring) and/or fiber concentration in the body of water about 3 gr/gal to about 1500 gr/gal, preferably about 15 gr/gal to about 200 gr/gal. However, in certain embodiments, much higher attractant (flavoring) and/or fiber concentrations may be used. For example, high attractant (flavoring) and/or fiber conditions may be defined as concentrations greater than 150 gr/gal, up to maximum obtainable levels. In certain such embodiments, the composition is introduced to the body of water so as to provide a attractant (flavoring) and/or fiber concentration in the body of water up to about 750 gr/gal, up to about 1000 gr/gal (particularly when biomass cleanup is not a concern), up to about 1200 gr/gal, up to about 1500 gr/gal, up to about 3,000 gr/gal (particularly when faster eradication is desired and/or little to no consideration for aquatic life and/or little to no consideration for residue in equipment), up to about 4,500 gr/gal, or up to about 6,000 gr/gal. In certain embodiments, the composition is introduced to the body of water so as to provide an attractant (flavoring) and/or fiber concentration in the body of water at a concentration of about 10 gr/gal to about 6,000 gr/gal, preferably about 15 gr/gal to about 3,000 gr/gal. It should be understood that even higher attractant (flavoring) and/or fiber concentrations may be used, depending on the particular application and solubility of the source of attractant (flavoring) and/or fiber.

Additionally, when the composition comprises a nonnative source of attractant (flavoring) and/or fiber, the concentration and duration of the treatments can be selected so as to provide effective short-term or long-term kill. In certain preferred embodiments, the composition is introduced to the body of water so as to provide an average attractant (flavoring) and/or fiber concentration in the body of water over the duration of treatment of about 3 gr/gal to about 4 gr/gal for about 3 to about 4 days. In certain preferred embodiments, the composition is introduced to the body of water so as to provide an average attractant (flavoring) and/or fiber concentration in the body of water over the duration of treatment of about 6 gr/gal to about 8 gr/gal for about 1 to about 2 days. In certain preferred embodiments, the composition is introduced to the body of water so as to provide an average attractant (flavoring) and/or fiber concentration in the body of water over the duration of treatment of at least about 60 gr/gal for less than about 24 hours. Saturated concentrations of attractant (flavoring) and/or fiber may also be used, depending on factors such as the presence of aquatic life and urgency of remedy. For example, the composition may be introduced so as to provide upper hypereutrophic levels of attractant (flavoring) and/or fiber when aquatic life is not of concern. Additionally, in highly infested bodies of water (i.e., with a large number of zebra mussels within an area), greater concentrations of attractant (flavoring) and/or fiber may be needed to achieve sufficient kill. Therefore, in certain embodiments, the composition is introduced to the body of water so as to provide an attractant (flavoring) and/or fiber concentration in the body of water at a concentration of at least about 100 gr/gal, at least about 200 gr/gal, at least about 500 gr/gal, at least about 1,000 gr/gal, at least about 10,000 gr/gal, at least about 16,000 gr/gal, at least about 50,000 gr/gal, at least about 100,000 gr/gal, at least about 130,000 gr/gal, at least about 160,000 gr/gal, or at least about 200,000 gr/gal.

The efficacy of the treatment methods can be dependent on several variances including, but not limited to, water temperature, salinity, toxins, oxygen level, age of mussels, current flow, turbidity, and pH. For example, older mussels can be killed at lower doses of the composition. The turbidity and pH of the water can impact both the efficacy of controlling invasive mussels as well as the survival of desirable aquatic life. In certain embodiments, the turbidity of the body of water is maintained at about 5 to about 500 ppm. In certain embodiments, and pH of the water is maintained at about 4 to about 8, or about 7 to about 8.

As noted above, the source of solids (or fibrous material) and/or attractant can comprise a material collected from the body of water to be treated. Therefore, in certain embodiments, the methods further comprise collecting an aquatic plant and/or algae material from the body of water and artificially processing the material before introducing the material into the body of water. For example, in certain such embodiments, the collected aquatic plant and/or algae is ground or blended into particulates. This artificial processing advantageously allows for increased exposure of the fibrous material and/or attractant content within the plant or algae when re-introduced into the body of water. In particular, the processed material smell and taste is released in greater abundance, with reduction in size allowing overindulgence by the Dreissenid species. The artificial processing may further comprising mixing the material with flavorings or other additives, as discussed above, before re-introducing the material to the body of water.

In certain embodiments, the method further comprises monitoring the attractant (or flavoring) concentration and/or concentration of fibrous material within the body of water. The monitoring can be performed with a permanent monitor (e.g., installed at a permanent location in the body of water) or by intermittent manual readings. Monitoring the attractant (or flavoring) concentration and/or fibrous material concentration at the body of water can be used to determine the amount and intervals of treatments with the composition to maintain a predetermined concentration to effect enhanced filtration, thereby providing an uptake of the fibrous materials (e.g., cellulosic fibers or solid) to kill and/or prevent infestation or spread of the invasive mussel species.

Embodiments of the present invention are also directed to systems for controlling the growth and spread of invasive mussel species. The systems generally comprise a dosing station configured to introduce the composition to the body of water. In certain embodiments, the system further comprises an attractant (or flavoring) concentration and/or concentration of fibrous material monitor residing in the body of water and configured to measure the concentration of the attractant (or flavoring) as well as fiber density at a location in the body of water. The dosing station can comprise a reservoir for storing the composition and an outlet for introducing the composition to the body of water. The outlet can be configured to introduce the composition, for example, by pouring, spreading, or spraying the composition onto the surface of the body of water, or injecting the composition into the body of water below the surface. The outlet may also be configured to provide an animalia feed comprising the composition to or around the body of water for consumption by animalia, such as fish and waterfowl. The system may further comprise a controller in communication with both the monitor and dosing station. In use, the controller instructs the dosing station to introduce an amount of the composition to the body of water to maintain the attractant (or flavoring) concentration, dependent on the attractant (or flavoring) being used in the body of water at a predetermined level as measured by the monitor. The dosing stations can be located anywhere that mussel control (i.e., kill or prevention) is desired. In particular embodiments, the dosing station is located at one or more freshwater inlets.

The particular form of the composition can be selected based on certain advantages for certain applications. For example, artificially modified or processed aquatic plants (e.g., grass or leaf plants) and/or algae may be advantageous so as to not inadvertently introduce other potentially invasive organisms to the body of water. Additionally, a plant leaf source compressed into a formation releases at a slower rate than powder or liquid forms, and thus such a source may be advantageous for slow-release applications. Spirulina and chlorella have a stronger affinity for osmosis into water than grasses or leaf substances with, and leaf substances seem to be eaten by fish more readily. In certain embodiments, the composition excludes grass and/or leaf plants. Chlorella has a higher concentration of flavor than spirulina, which can be advantageous for closed areas, such as piping and equipment. Additionally, spirulina is larger in size than chlorella. Therefore, in other embodiments, both natural and chemical, the considerations experienced between chlorella and spirulina flavor and size should be considered. In certain embodiments, the composition comprises a mixture of chlorella (for smaller mussels) and spirulina (for larger particles and larger mussels). This mixture may also comprise a leaf source (such as alfalfa) that aquatic life readily consumes. Such a mixture can provide a multi-faceted approach to controlling the spread of invasive mussels. In particular embodiments, the composition comprises alfalfa, spirulina, and/or sesame. Mixtures of spirulina and alfalfa pellets are particularly advantageous for treatments in areas when considering preservation of aquatic life, as fish, snails, crayfish and insects. In other particular embodiments, the composition comprises corn gluten meal and another a source of attractant and/or fiber, such as alfalfa. Such mixtures are particularly advantageous treatments for areas where invasive mussel infestation has depleted the available nutrients for aquatic life.

In certain embodiments, the composition does not comprise heavy metals, such as copper, commonly used in prior art treatment methods. Heavy metals can be precursors to several neurological conditions and concentrations can increase over time in bodies of water treated with prior art methods. Therefore, in certain embodiments, the methods and systems advantageously do not comprise introducing additional heavy metals to the body of water (i.e., that are not present in nature or harvesting of material(s). Additionally, the use of pesticides has known and possibly unknown health risks to humans. Therefore, in certain embodiments, the methods and systems advantageously do not comprise introducing a pesticide to the body of water.

Compositions, methods, and systems in accordance with embodiments of the present invention may have a variety of advantages, such as those described above. Additionally, in certain embodiments, the compositions, methods, and systems described herein may provide additional advantages to desirable natural species, crops, and/or livestock. For example, in certain embodiments, the compositions may be beneficial to natural plants and crops, providing depleted or supplemental nutrients to the natural plants and crops. Additionally, in certain embodiments, the compositions may be used as a nutritional supplement in animal feed, for example, for animal species in the surrounding environment and/or to livestock.

Additional advantages of the various embodiments of the invention will be apparent to those skilled in the art upon review of the disclosure herein and the working examples below. It will be appreciated that the various embodiments described herein are not necessarily mutually exclusive unless otherwise indicated herein. For example, a feature described or depicted in one embodiment may also be included in other embodiments but is not necessarily included. Thus, the present invention encompasses a variety of combinations and/or integrations of the specific embodiments described herein.

As used herein, the phrase “and/or,” when used in a list of two or more items, means that any one of the listed items can be employed by itself or any combination of two or more of the listed items can be employed. For example, if a composition is described as containing or excluding components A, B, and/or C, the composition can contain or exclude A alone; B alone; C alone; A and B in combination; A and C in combination; B and C in combination; or A, B, and C in combination.

The present description also uses numerical ranges to quantify certain parameters relating to various embodiments of the invention. It should be understood that when numerical ranges are provided, such ranges are to be construed as providing literal support for claim limitations that only recite the lower value of the range as well as claim limitations that only recite the upper value of the range. For example, a disclosed numerical range of about 10 to about 100 provides literal support for a claim reciting “greater than about 10” (with no upper bounds) and a claim reciting “less than about 100” (with no lower bounds).

### EXAMPLES

The following examples set forth methods and compositions in accordance with embodiments of the present invention. It is to be understood, however, that these examples are provided by way of illustration, and nothing therein should be taken as a limitation upon the overall scope of the invention.

### Example I

Various potential attractants were used to demonstrate the benefit in using attractants in to increase the filtering and digestion of substances not normally accepted by Dreissenid Mussel species, such as Dreissena Polymorpha (commonly known as zebra mussels) and Dreissena Rostriformis Bugensis (commonly known as Quagga Mussels), both having common digestive systems known as filter feeders. Visual observations were made, with signs of filtering and/or digestion including shells opening to expose the soft tissue inside.

### Experiments

In a first experiment, zebra mussels were submerged in a container comprising distilled water and fully developed sesame plant (as fibrous material) at a concentration of 40 grains of sesame per gallon. Zebra mussels did not show any signs of filtering or digesting for 48 hours.

In a second experiment, decaying anchovies (as potential attractant) were added to the water. Again, zebra mussels did not show any signs of filtering or digesting for 5 days.

In both cases of the above cases, the water comprising the attractant was removed and replaced by clean water. Within minutes of being placed in the clean water, the zebra mussels showed signs of filtering or digesting.

In a third experiment, a lower concentration of adult sesame plant was used. Again, zebra mussels did not show signs of filtering or digesting.

In a fourth experiment, the lower concentration of sesame was used and spirulina was added. This time, the zebra mussels showed signs of filtering and digesting.

In a fifth experiment, the concentration of decaying anchovies was reduced and soybean powder (as an attractant) was added at a concentration of about 30 grains per gallon. No sesame or spirulina was used. In this case, the zebra mussels showed signs of filtering and digesting, after the reduction of decaying anchovies concentration within the aquatic environment.

In a sixth experiment, formulations comprising 100% sesame plants were used in two separate tests, one source being in the juvenile stage (pre-bloom) and the other in adult stage, to test the hypothesis that processing plants in different stages could both improve and reduce eradication outcomes. The experiment using the processed adult stage sesame plant mixture resulted in closure of the zebra mussel for several days before removing (i.e., no filtration or death). The experiment using the processed juvenile stage sesame resulted in continued filtering by the zebra mussels as visually seen openly filtering and resulting in death as seen with other favorable plant sources.

Oxalic acid (oxalate) testing was performed using sesame fluor, mature sesame plants (with blooms), and juvenile sesame plants (˜3 inches tall, with no blooms). The mature and juvenile plant samples were ground into powder. All samples were diluted with varying amounts of distilled water. As shown in FIGS. 1-3, mature sesame and sesame flour showed higher concentrations of oxalates than juvenile sesame. The results are also quantified in Table 1 below.

TABLE 1
Oxalate Quick Test Strips Approximate Readings of
Oxalate (mg/dl, oxalate) Using Different Sesame Sources
in Varying Levels of Distilled Water

| Dilution in | Sesame | Processed Adult | | Processed Juvenile |
|---|---|---|---|---|
| Distilled Water | Seed Flour | Sesame Plant | | Sesame Plant |
| 5 oz | 1.5 mg/dl | 0.75-1.5 | mg/dl | 0 mg/dl |
| 7.5 oz | 1.0 mg/dl | — | | 0 mg/dl |
| 10 oz | 0.5 mg/dl | 0 | mg/dl | 0 mg/dl |
| 12.5 oz | 0 mg/dl | 0 | mg/dl | 0 mg/dl |

### DISCUSSION

The results demonstrate that the taste and flavor content (e.g., in aquatic and/or non-aquatic plants) can be used to attract Dreissenid mussels to increase filtration for solid particles (e.g., fibrous materials, including cellulosic fibers) to obstruct Dreissenid mussel digestion, which results in death. The studies, as well as microscope observations, show that bio-mass products comprising cellulous from plant sources provides the blocking action of the Dreissenid mussel digestive tract.

It has been determined through extensive trials that Dreissenid mussels do not filter some plants as well as other because they recognize chemicals, compounds, and structures that cause discomfort, resulting in reduced filtering, thereby reducing the effectiveness of using chlorophyll as an attractant to increase filtering of solids to a result of internal blockage.

Two approaches are recognized to remove retardants (e.g., oxalates) from the favorable flavor/cellulous (solid) mixture. One approach is to chemically and/or mechanically remove such retardants to make the flavorable/cellulous (solid) mixture more palatable to the Dreissenid mussels. A potentially preferred approach that may be more ecologically, as well as economically, accepted is to harvest aquatic and/or non-aquatic plants prior to retardant formation as a chemical, compound, or structure at increased levels in the plants (i.e., at levels that are no longer palpable to the Dreissenid Mussels). In the study above performed using the Sesamum indicum (aka Sesame), different levels of oxalates were identified at different plant life stages and sources. However, retardant substances of different chemical, compound, and structures may be developed in other plant species.

The results above demonstrate that, when using the attractant (flavoring)/solids concentration from adult plants at 100% concentration, Zebra Mussels were seen to stop filtering as indicated by closing their shells. While using the accepted flavors/solids concentration from juvenile plants at 100%, Zebra Mussels filtered the substance as indicated with open shells showing internal soft tissues. Table 1 and the associated figures show oxalate concentrations in the different sesame sources. Oxalates, which can cause adverse effects in both insects and humans, appear to be instinctively recognized as harmful by Zebra Mussels.

### CONCLUSIONS

Compositions comprising favorable flavorings and tastes and solids (both expanding and non-expanding, e.g., fibers) can be both chemically man-made substances or from plant substances, and can be used to control (i.e., eradicate or prevent infestation of) Dreissenid mussels (Zebra Mussels and Quagga Mussels). A preferred source of flavoring can act as an enticing product to increase filtration, and the solids can be used to create a blockage within the digestive system. A preferred source of attractant/flavoring and/or solids includes either aquatic or non-aquatic plant species. Using aquatic or non-aquatic species provides biodegradable substances while also lowering the processing impact of possible bi-product chemical waste and waste of natural resources through processing of man-made favorable taste and solids. Such plant species generally comprise favorable flavoring of pleasant taste and cellulose/fibrous material.

A first conclusion drawn from the above experiments is that, although zebra mussel eradication is possible with various sources of flavors and/or fibrous materials, the process may be improved by concentrating favorable attractants. The favorable attractants may be in many forms, including both organic and chemical based.

A second conclusion drawn from the above experiments is that, although zebra mussel eradication is possible with various sources of flavors and/or fibrous materials, the successful process is reduced when plants of high oxalic acid (e.g., mature sesame), pungent or decaying tissues are used as a source of attractant.

A third conclusion drawn from the above experiments is that juvenile plants do not develop high oxalic acid, thus making the plant a favorable source of fibrous material and/or attractant.

A fourth conclusion drawn from the above experiments is that some adult plants develop known chemicals (e.g., oxalic acid) that Dreissenid mussels recognize as being harmful to their wellbeing.

A fifth conclusion drawn from the above experiment is that oxalic acid is one chemical that Dreissenid mussel species recognize as harmful and therefore refrain from filtering if possible, as seen with adult sesame plants when used as an active ingredient and inactive ingredient.

A sixth conclusion is that many plants produce chemicals to protect themselves, and the chemical concentrations differ in the stages of plant life, making it desirable to process plants at selected stages of growth. Thus, this is a consideration not only in addressing zebra mussels, quagga mussels, but also other uses when using a plant as a source of attractant, active ingredient, inert ingredient, or inactive ingredient.

A seventh conclusion is that unflavored fibrous materials have little effect in increasing zebra mussel filtration compared to increasing flavor and fibrous concentration within the Dreissenid living environment.

An eighth conclusion is that although a product can be produced to eradicate or lessen a zebra mussel population, the same product may have value in replacing aquatic nutrients that are beneficial fish, plankton, zoo plankton, plants, other mollusks in short term introduction, crustaceans, gastropods and plants when used considering before species tolerance of any source of flavoring and fiber, unlike nonspecific use of bacteria and heavy metals, such as copper.

### Example II

An exemplary formulation comprising fibrous material and attractant was prepared (in weight %):

5% Sesame

3% Corn Starch

5% Sucrose Sugar

5% Spirulina

82% Alfalfa

In one embodiment, the exemplary formulation may be characterized as:

| | |
|---|---|
| Active Ingredient (Sesame): | 5% |
| Inactive Ingredients (Alfalfa, Spirulina, Sugar, Cornstarch): | 95% |

Without being bound by any theory, it is believed that the exemplary formulation is particularly effective because:
1. spirulina is readily acceptable by the mussels and is thus an effective source of fibrous material and/or attractant;
2. alfalfa is an inexpensive component to provide additional base material as a fibrous material;
3. corn starch prevents caking of the powdered formulation; and
4. sucrose acts as a preferred attractant.

### Example III

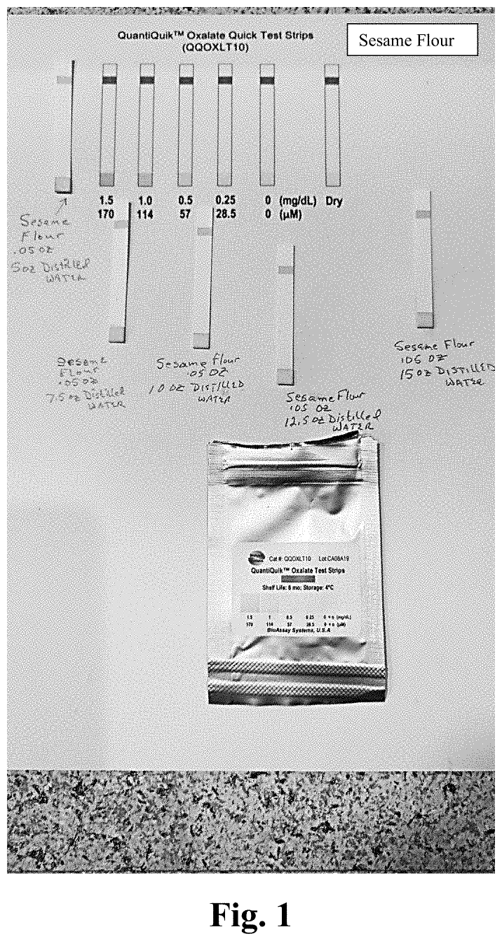

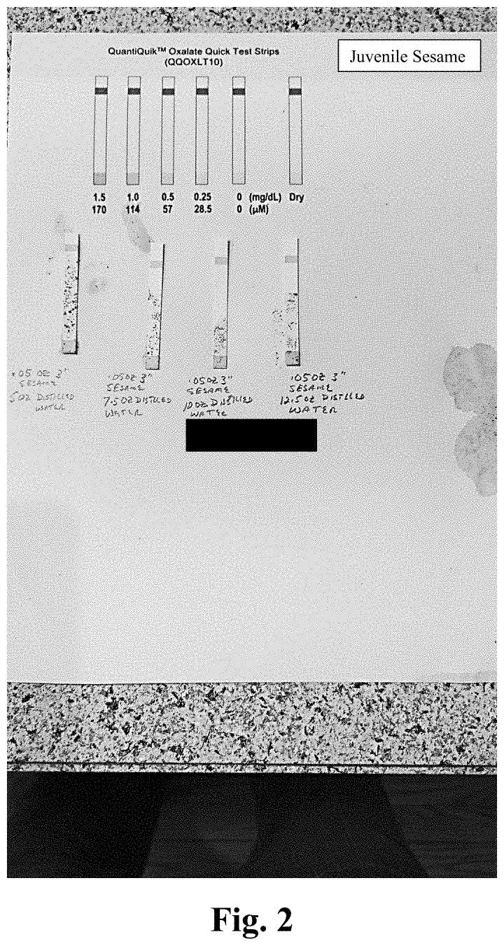

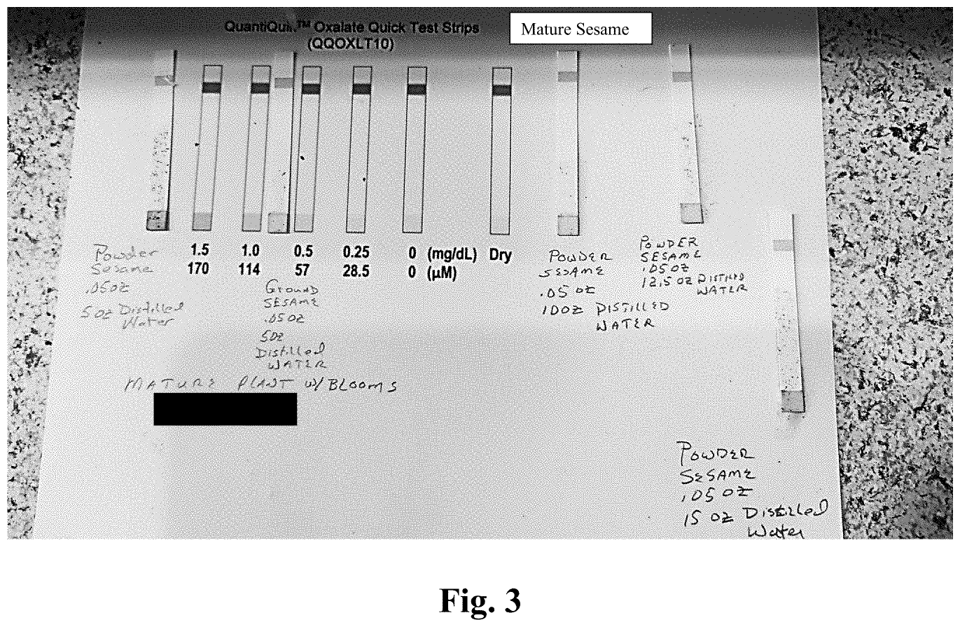

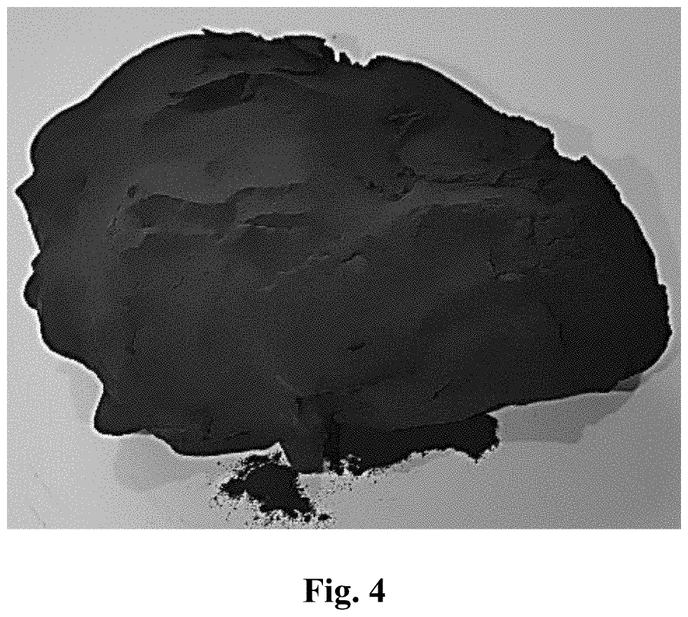

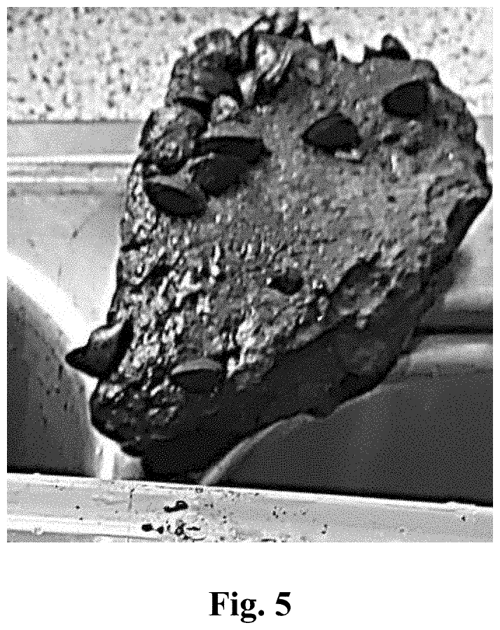

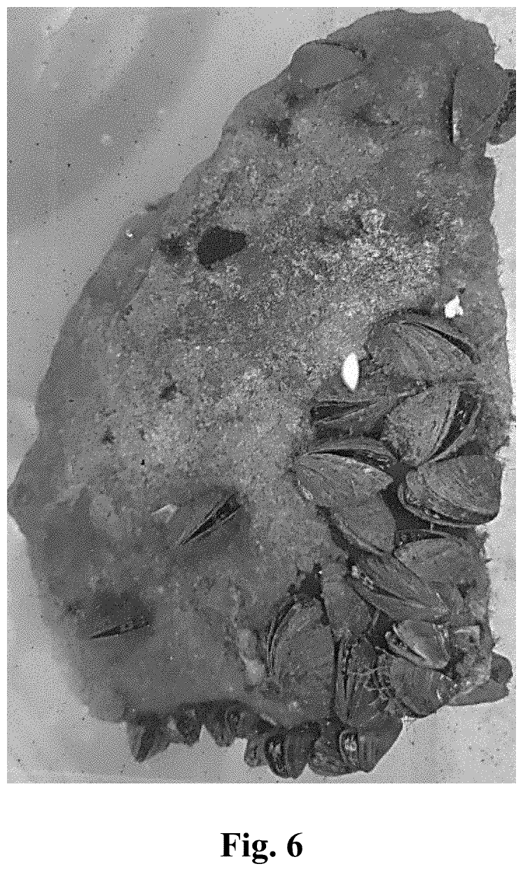

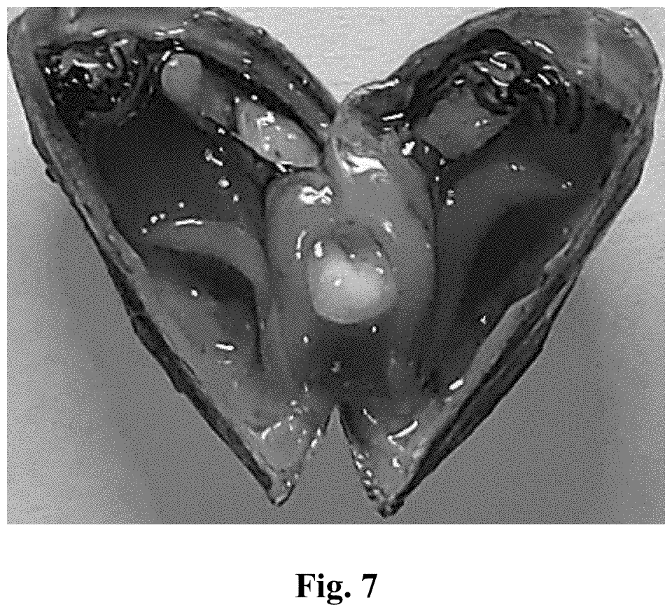

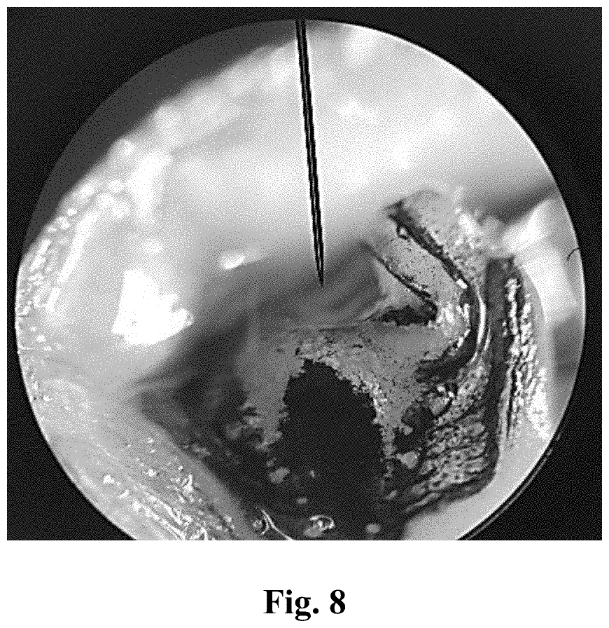

Fine powder dry biomass (spirulina) was layered over a small rock with 30 Zebra Mussels (FIG. 4). The dry biomass was removed after 12 hours, and rinsed (FIG. 5). The Zebra Mussels and rock were then placed in fresh water, where they opened and remained alive for at least 2 hours. After 6 hours, it was noticed that all 30 Zebra Mussels were dead, as they no longer reacted to tapping or shaking. Dissection of the dead Zebra Mussels provided evidence of biomass buildup (FIGS. 7 and 8). This experiment suggests that the Zebra Mussels are not able to resist favorable attractants over favorable conditions.

### Example IV

A study was performed to determine whether zebra mussels could be attracted to engorge cellulose fiber by substances other than chlorophyll. It was confirmed in the study that there are many favorable flavors that attract zebra mussels with the presence of a wide variety high level of cellulous/fiber. Both natural and synthesized substances, when filtered at a high volume, resulted in zebra mussel overeating to the point the digestive system is exhausted and blocked.

For the demonstration, it was decided to use corn gluten meal, a product that is used in agriculture feed to elevate protein concentrations. Corn gluten meal is the principal protein of corn endosperm comprising mainly of zein and glutelin. Corn gluten meal is a byproduct of corn processing that has a long history of being used as an animal feed ingredient. Typical quoted feed material where corn gluten meal can be found is cattle, poultry, fish, and dog feed, as reported by Illinois Extension. As a registered feed ingredient history of safety, it was decided corn gluten could provide a combination of taste (attractant) and a fiber source when milled to a size that is consumable by the size of Zebra Mussels and Quagga Mussels. The Dreissena Polymorpha species rapid filtering action makes a perfect candidate for eradication of flavor and fiber, where most bivalve species control their eating consumption.

Equipment used during the demonstrations included several colonies (several zebra mussels attached to a single rock), bowl containers, air bubbler, circulation pumps distilled water, camera, wine glass, scales (measuring weight in grains) and timer. The corn gluten meal used in this experiment had the nutrient composition shown in Tables 2 and 3 (% by weight unless otherwise indicated):

TABLE 2
Corn gluten nutritional information

| | |
|---|---|
| Crude Protein | 60.0% |
| Fat | 02.5% |
| Crude fiber | 02.0% |
| Neutral Detergent Fiber | 12.6% |
| Acid Detergent Fiber | 06.2% |
| Calcium | 04.5% |
| Phosphorus | 00.5% |
| Total Digestible Nutrients | 83.0% |

TABLE 3
Guaranteed Analysis

| | |
|---|---|
| Crude Protein | 60.0% minimum |
| Crude Fat | 1.0% minimum |
| Crude Fiber | 3.0% maximum |

To prepare the corn gluten meal for use, the particle size was reduced to powder. In particular, purchased corn gluten meal having an average particle size (i.e., median particle diameter, D50) of about 0.08 inch to about 0.15 inch was further reduced in size (via grinding) to form a corn gluten meal powder with at least about 94% of the powder having a particle size (largest lateral diameter) of about 0.002 inch to about 0.008 inch.

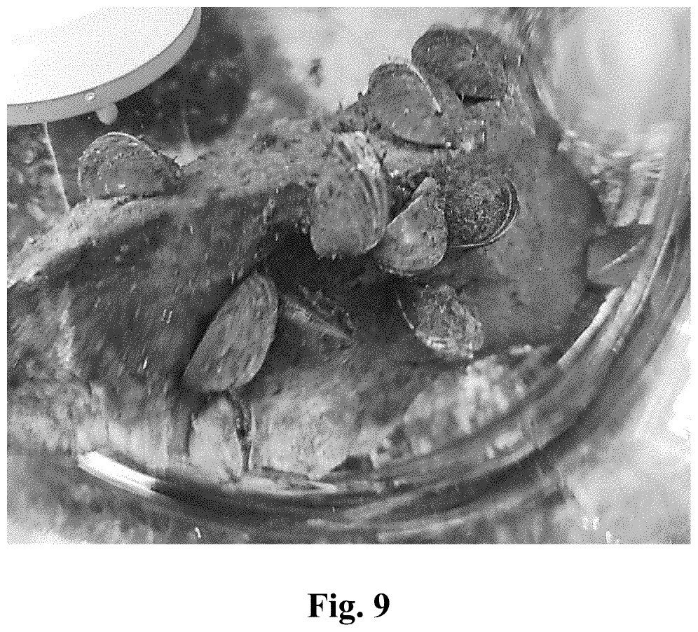

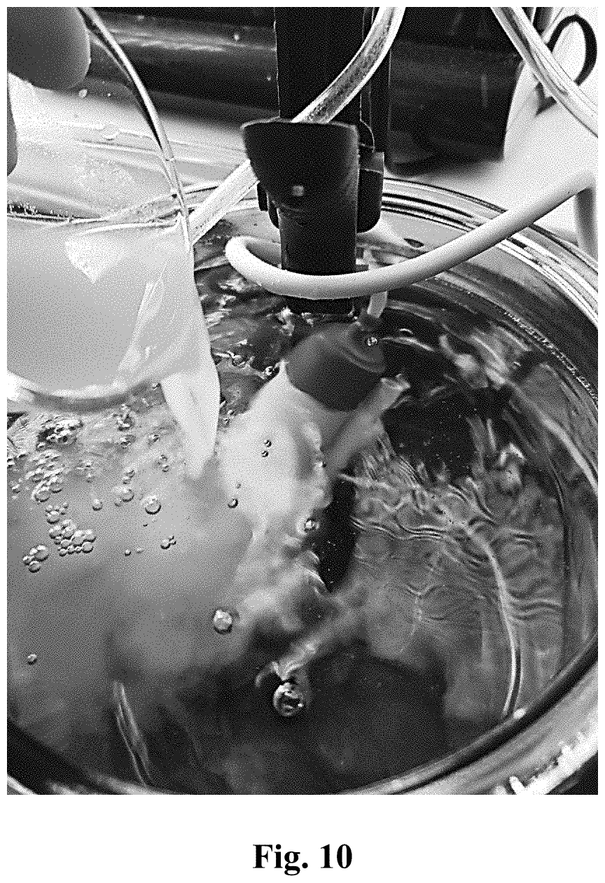

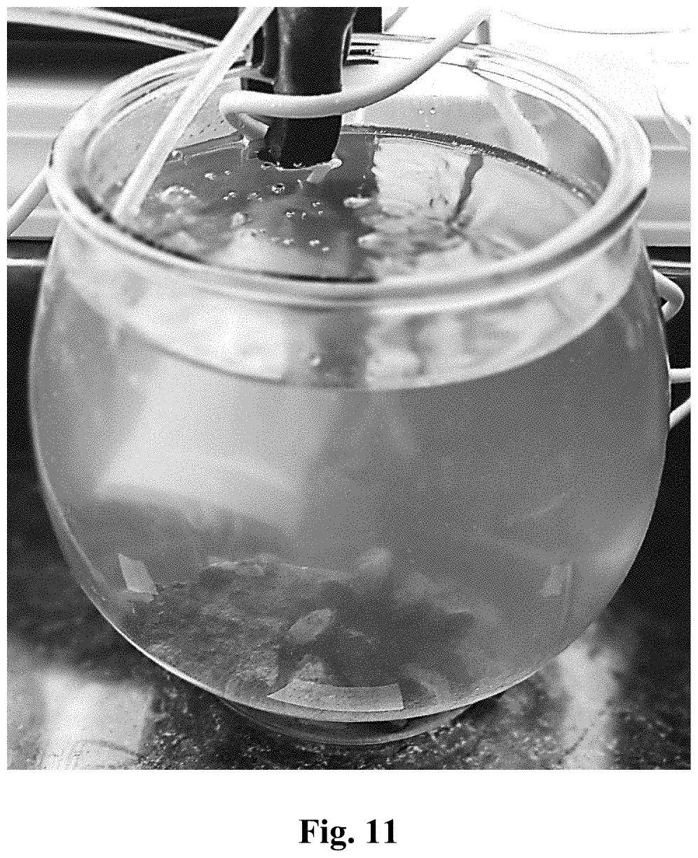

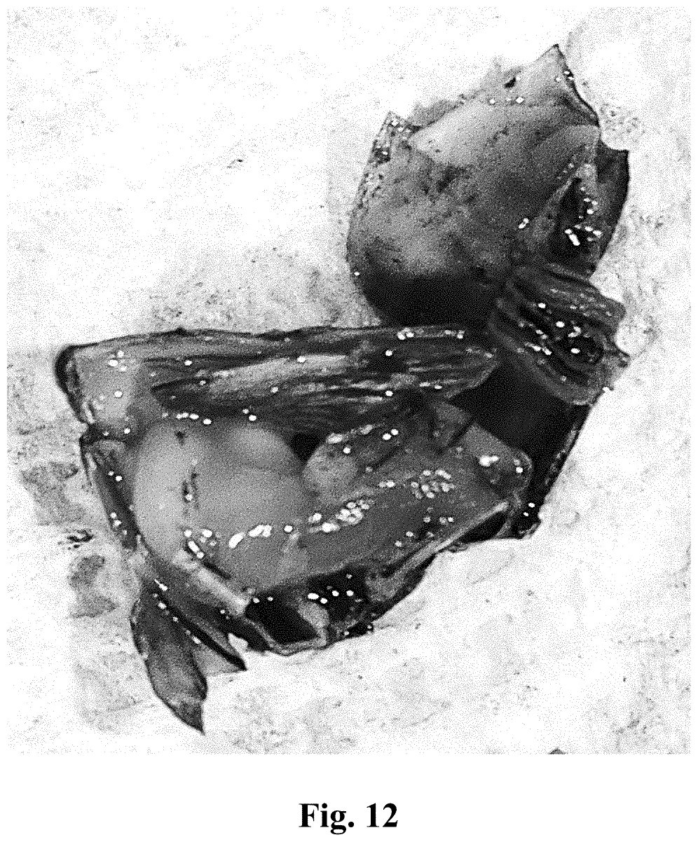

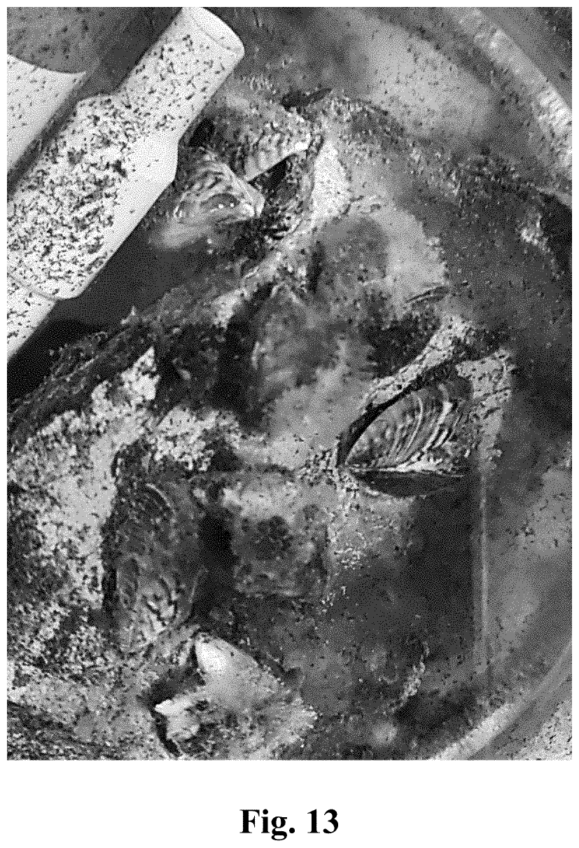

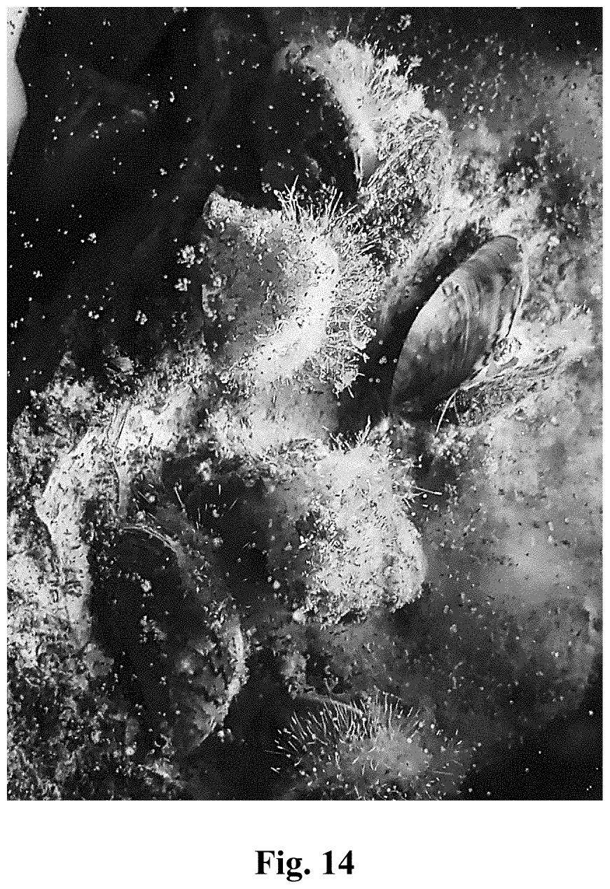

The experiment was carried out as follows:
1) Placed one gallon of distilled water into a bowl container.
2) Placed a colony of zebra mussel into the bowl filled with water (See FIG. 9).
3) Placed air bubbler into the bowl filled with water and containing zebra mussels.
4) Placed water circulating pump into the bowl filled with water, containing zebra mussels and air bubbler.
5) Set aside a quantity of 100% ground to powder corn gluten meal.
6) Removed approximately 20 ounces of water from the bowl described in step four.
7) Added the 100% ground to powder corn gluten meal to one 20-ounce container.
8) Poured the mixed 100% powdered and 20-ounce container of water into the before mentioned bowl (See FIG. 10).
9) With air bubblers on and pumps recirculating, allowed the zebra mussels to filter the mixtures for two hours (See FIG. 11).
   Note: Upon tapping the colonies, it was noticed that the zebra mussels filtering the 100% corn gluten meal mixture would no longer respond by closing when tapped.
10) Removed one non-responding zebra mussel from the 100% corn gluten meal mixture.
   Note: Observation of the digestive system was accomplished by prying the dead zebra open. After opening it was visually obvious that the 100% corn gluten meal mixture had blocked and engorged the digestive system, resulting in death in less than two hours (See FIG. 12).
11) An approximately 16 ounces of the water/100% corn gluten meal was then extracted from the bowl, being placed in high quality wine glasses for observation after dehydrating.
   Note: 8 days later, the water had evaporated, and corn gluten meal solids residue was present, confirming that the corn gluten meal solids were suspended in the water two hours after initial treatment.
12) The mixtures water/100% corn gluten meal bowls were left in place undisturbed except to replenish evaporated distilled water for 25 days.
   Note: At the end of 25 days from beginning the experiment, the bowl of zebra mussels in the 100% corn gluten meal showed evidence of decay (See FIG. 13), with a growth growing out of the tissues (See FIG. 14).

Based on the experiment above, the following conclusions can be made:
1) Actions demonstrated that chlorophyll is not the only flavor that attracts and promotes zebra mussel digestion.
2) Corn Gluten Meal is an example that favorable flavor and cellulous/fiber, both as found in nature and synthesized substances, increases filtering and blockage of the zebra mussel digestive system.
3) Corn Gluten Meal flavor, nutrient attraction and fiber performed within two hours.
4) Use of corn gluten meal may introduce fewer nonnative substances than other materials and combinations.

### Example V

A multi-purpose composition was prepared that provides for a minimum risk pesticide, an aquatic food (i.e., nutrient supplement), and/or a source of plant nutrient. The composition was prepared by mixing 15% by weight of corn gluten meal (60% protein) was mixed with 85% by weight of dried alfalfa (15% protein). The resulting composition includes suitable components for killing invasive mussel species while also being non-harmful to other aquatic life and providing 21% by weight of food protein content.

1. A method of controlling the spread of an invasive Dreissenid mussel species comprising introducing a composition comprising a source of solids and an attractant to a body of water.

2. The method of claim 1, wherein the source of solids comprises a source of fibrous materials.

3. The method of claim 2, wherein the source of fibrous materials is selected from the group consisting of cellulosic fibers, plastics, polymers, textiles, rubbers, papers, glass, animalia tissues or feces, and mixtures thereof.

4. The method of claim 2, wherein the source of fibrous materials comprises a plant and/or organism selected from the group consisting of corn or corn by-product(s), sesame, cyanobacteria, alfalfa, soybeans, wheat grass, wheat straw, barley grass, mulberry, chlorella, seaweed, freshwater moss, spirulina, garlic, wormwood, colocynth, bay laurel, pennyroyal, myrtle, oleander, basil, marjoram, thyme, algae, and mixtures thereof.

5. The method of claim 1, wherein the attractant is selected from the group consisting of corn gluten meal, alfalfa, sugars, nonnative sources of chlorophyll and/or other nutrients, blended fish or fish meal, corn syrup, alcohols, hemp, and mixtures thereof.

6. The method of claim 1, wherein the body of water has a turbidity of about 5 ppm to about 500 ppm after introducing the composition.

7. The method of claim 1, wherein the method does not comprise introducing additional heavy metal to the body of water.

8. The method of claim 1, wherein the introducing comprises pouring, spreading, or spraying the composition onto the surface of the body of water, or injecting the composition into the body of water below the surface of the water, or feeding the composition to an animalia that defecates in the body of water.

9. The method of claim 1, wherein the body of water has a pH of about 4 to about 8 after introducing the composition.

10. The method of claim 1, wherein the composition is provided in a form selected from the group consisting of vapor, liquid, paste, powder, pellets, cubes, blocks, animalia food, and combinations thereof.

11. A method of controlling the spread of an invasive Dreissenid mussel species comprising introducing a composition comprising corn gluten meal to a body of water.

12. The method of claim 11, wherein the composition comprises at least about 90% by weight of corn gluten meal.

13. The method of claim 11, wherein the composition comprises from about 1% to about 50% by weight corn gluten meal and from about 50% to about 99% by weight of another attractant and/or another source of fibrous materials.

14. The method of claim 11, wherein the composition comprises particles having a D50 of about 0.00001 inch to about 0.04 inch.

15. A composition for controlling the spread of an invasive Dreissenid mussel species comprising:
a source of solids;
an attractant; and
optionally, an anti-caking agent.

16. The composition of claim 15, wherein the source of solids comprises a source of fibrous material.

17. The composition of claim 15, wherein the composition consists essentially of corn gluten meal as the source of solids and the attractant.

18. The composition of claim 15, wherein the composition comprises corn gluten meal and alfalfa.

19. The composition of claim 18, wherein the composition comprises from about 1% to about 50% by weight corn gluten meal and/or from about 50% to about 99% by weight of the alfalfa.

20. The composition of claim 15, wherein the composition comprises particles having a D50 of about 0.00001 inch to about 0.04 inch.
